(19) United States
(12) Patent Application Publication
(10) Pub. No.: US 2004/0035644 A1
(43) Pub. Date: Feb. 26, 2004

(54) Customer order fulfillment method, system, and device

(76) Inventors: Russell Ford, Atlanta, GA (US); Salvatore Veni, Dacula, GA (US)

Correspondence Address: LIU & LIU LLP, 811 West 7th Street, Suite 1100, Los Angeles, CA, 90017, US

(21) Appl. No.: 10/256,677

(22) Filed: Sep. 27, 2002

Related U.S. Application Data
(60) Provisional application No. 60/405,440, filed on Aug. 23, 2002.

(51) Int. Cl. E04H 3/04; B61B 1/00; B65G 1/00; E04H 3/00

(52) U.S. Cl. 186/41; 186/53

(57) ABSTRACT

A low-cost paging based order fulfillment method, system, and apparatus that allows customers to easily indicate their arrival at a place of business without entering the business or using voice based communications and which is able to simultaneously transmit specifically identifiable information to relevant employees for purposes of expediting delivery of customer purchases. Customers arriving at the place of business in a vehicle are allowed to remain in the vehicle during the entirety of the notification and delivery process. The business may designate specific employees for receipt of customer notification and identification data for quick payment processing and delivery of customer purchases.

This application makes a claim of priority from U.S. Provisional Application No. 60/405,440 (attorney docket no. 1124/201), entitled “To-Go Terminal and Process”, filed Aug. 23, 2002 in the name of Ford et. Al, which is assigned to NTN Communications Inc., the assignee of the present invention, which application is fully incorporated by reference herein.

### BACKGROUND OF THE INVENTION

1. Field of the Invention

This invention relates generally to a remote notification method, system and device for facilitating customer order fulfillment in a particular business setting, namely the food service industry. More specifically this invention provides a cost effective system for relaying the arrival status and identifying information of a customer at a food service or similar business establishment. A communication device is also disclosed which wirelessly transmits specifically identifiable information from one party to another for purposes of order processing and delivery.

2. Description of Related Art

Modern customer order fulfillment systems for the food service industry require technology-based elements to facilitate various functions, such as remote communication between customers and business employees/attendants. Conventional remote communication systems used in the food service industry range widely in their scope and application. Many business purposes and functions require voice based communication means such as telephones, intercoms, two-way radios, and other such devices. Other purposes may require the use of internet based communication means such as email, instant messaging, or online ordering systems. Still other purposes require video relays, video conferencing, and/or motion or other sensing devices. For simple notification applications, remote paging systems may be used to send alphanumeric characters to a designated party via a paging device. U.S. Pat. No. 4,518,961 entitled “Universal paging device with power conservation” which describes paging devices and methods in detail is hereby incorporated by reference.

For most general business applications, any number of the above listed notification and communication means can be used to accomplish a particular purpose, however, for businesses in the food service industry, whose nature generally requires the timely delivery of purchases to customers, most of the above methods have proven deficient (i.e. not cost effective, too time consuming, etc).

Many full service restaurants have expanded their customer base and revenue producing abilities by allowing customers to place “to-go” orders rather than requiring customers to dine in the restaurant. More customers can be served on a given day in this way, and restaurants are able to stay more competitive with the fast food restaurants which appeal to time conscious customers. A general description of the “to-go” ordering process addressed by this invention is as follows: A customer pre-places an order for a meal at a restaurant, generally by telephone, internet ordering means, or other known ordering method. When the customer arrives at the restaurant (typically by vehicle), they must find a free parking space, exit their vehicle, enter the restaurant, and wait, often in a designated area, to pay for and receive their previously placed order. It is often the case that crowded parking lots, long to-go order lines, and general lack of a restaurants ability to maintain order delivery in an organized and timely manner frustrates customers, and may adversely affect their decision to frequent the to-go services of that restaurant.

With the to-go order processing system described above, customers arrive at the restaurant presumably around an estimated time designated by the restaurant for fulfillment of their order. In most cases, many other customers having also previously placed orders will be arriving at the restaurant around the same time (depending on the amount of orders placed around a given time and the capability of the restaurant to fill those orders), creating at times a backlog of orders to be filled. It is in these scenarios that timeliness and organization in the order processing and delivery system are essential. Such scenarios also highlight the deficiencies in current “to-go” notification, order processing, and delivery systems (collectively “fulfillment systems”).

Several solutions to the above problem have been attempted using existing technologies. For instance, voice based drive through stations have long been used in the fast food industry, however such stations are not ideal when applied to restaurants in which to-go orders, which are placed ahead of the customers arrival at the location, are used. Furthermore, voice based drive through stations are not always cost effective for restaurants in which to-go customers do not comprise a significant portion of the business for a given day. Voice based drive through stations are also not appropriate for restaurant businesses where food preparation takes significantly longer than the three to five minute average “fast food” preparation time frame. Additionally, voice based drive through stations are notorious poor in communications quality, and generally require the attention of one or more store employees for effective operation. It is further the case that voice based drive through stations could adversely effect the reputation of restaurants which do not desire to be classified as a “fast food” establishment.

Video based notification systems have also been used to facilitate to-go orders in restaurants. The deficiencies of such systems are easily illustrated however in that they are high cost, require the constant attention of one or more store employees, and do not adequately relay specifically identifiable information (such as a phone or customer ID number) from an arriving customer to store employees for quick processing of the customers order and delivery of the purchases. In other words, such systems still require excess employee time and effort to process and deliver customer to-go orders.

Traditional telephones (including mobile phones) and paging systems have been used to facilitate ordering and communication functions at restaurants, however such communication means require customer knowledge of specific phone or pager numbers and do not adequately relay the information necessary for store employers to process orders and deliver purchases. For instance, it is likely that anxious customers may place a call or page to a given food establishment before the customer actually arrives at the establishment to pick up the order if they were instructed to use conventional telephone and paging systems to facilitate order processing and delivery. In such a case, expedited delivery of orders to customers who are already waiting outside the food establishment would not be possible since the exact order of arrival by customers is not ascertainable by reference to the order in which calls or pages are received. The quality of service and organized delivery of orders would thus decrease using such a system.

Therefore, it would be desirable to create a new low cost and easy to implement order fulfillment system which enables customers at food service or similar businesses to easily indicate their arrival at the establishment while simultaneously transmitting relevant identifying information to the business employees. Thus in cases such as restaurants, customer orders may be fulfilled with minimized wait times by customers and without the constant attention of store employees, resulting in increased efficiency of the business and more satisfied customers.

### SUMMARY OF THE INVENTION

The order fulfillment system of the present invention overcomes the deficiencies in the prior art, and enables increased levels of service and efficiency for food service businesses in which organized and timely delivery of customer orders is essential. It is an object of the present invention is to provide a low-cost remote paging based order fulfillment method, system, and apparatus which enables food service businesses to allow simple customer arrival notifications which include relevant identifying information for particular orders, in order to expedite processing and delivery of all pending orders at the business in a timely and efficient manner.

According to a first aspect of the present invention, there is provided a remote paging based order fulfillment method for enabling simple ordering and delivery of purchases, comprising: An order placement and information designation step, wherein a customer pre-places an order at a business and indicates personal identifying information (such as a phone number) to an employee of the business; an arrival step, wherein the customer arrives at the business and proceeds to a remote paging station outside the business (for instance outside the building or physical structure housing the business); a data entry step wherein the customer enters the previously indicated personal identifying information into a keypad on the remote paging station; a send step wherein the customer initiates the transfer of information from the remote paging station to a notification device (typically a pager or pagers within the business worn by one or more employees); a notification step wherein the notification device alerts the employee and displays the customers personal identifying information, thus indicating to the employee both the customers arrival status and order information; a matching step where the employee matches the customers identifying information to a the customers order which has been tagged with such information; and a delivery step wherein the employee delivers the customers order to the customer.

In another aspect of the above method, there is a relocation step following the send step wherein the customer is directed to relocate to a designated area or areas for completion of the delivery step. Such designated areas may be parking spaces which have been previously marked for to-go customers. Signage means on or near the remote paging system may be used to indicate the location and manner in which customers are to relocate prior to delivery of their order.

In still another aspect of the above method, there is a payment step wherein the customer pays for the order via any number of known payment methods. The payment step may be performed during the initial order placement step, or may be performed any time during the process before delivery of the order has been made.

In an alternate embodiment, the payment step is performed during the data entry step, and may replace the identifying data input by the customer. For instance the remote paging station may be equipped with credit/debt card, smart card, or similar card reading apparatus for processing of payments. Identifying information from the transaction is then sent to the employee's wireless pager or other similar device for notification and order identification purposes.

According to a further aspect of the present invention, there is provided a remote paging system for order fulfillment which comprises a remote paging station apparatus for entry of customer identification information, and a paging device for notification and delivery of customer identification information. The paging station and paging device are connected via wireless means (such as UHF band wireless communication technologies) and use the well known POCSAG (Post Office Code Standardization Advisory Group) data transfer protocol, wherein the customer identification information may be transmitted remotely to the paging device.

According to still a further aspect of the present invention, there is provided a remote paging apparatus equipped with general-purpose data entry and display functions and used for entering customer identifying information, comprising: data entry means for facilitating information input by customers; a data translation means for mapping the customer input data to a specified paging data set for transmission to the business; a transmission means for sending, to one or more remote notification devices (generally wireless paging devices), the customer identifying information; and optional verification means (such as a light, display, or sound) for notifying customer that the identifying information was transmitted successfully.

In an additional aspect of the above remote paging apparatus, the components and parts thereof are modular, thus allowing easy access and repair/replacement of the various components without removal of the entire remote paging apparatus.

In another embodiment of the above remote paging apparatus, a credit/debt card, smart card, or similar card processing means is included in the remote paging apparatus for facilitation of customer order payment. Also included in this embodiment is a data processing means for selecting relevant data from the order payment process to send to the wireless paging device(s) for notification and order designation purposes.

The above method, system, and apparatus, and other objects, effects, features and advantages of the present invention will become more apparent from the following description of the embodiments thereof taken in conjunction with the accompanying drawings.

This invention has been described herein in reference to various embodiments and drawings. While this invention is described in terms of the best presently contemplated mode of carrying out the invention, it will be appreciated by those skilled in the art that variations and improvements may be accomplished in view of these teachings without deviating from the scope and spirit of the invention. This description is made for the purpose of illustrating the general principles of the invention and should not be taken in a limiting sense.

### BRIEF DESCRIPTION OF THE DRAWINGS

For a fuller understanding of the nature and advantages of the present invention, as well as the preferred mode of use, reference should be made to the following detailed description read in conjunction with the accompanying drawings.

FIG. 1 illustrates the remote paging system of the current method implemented at a restaurant.

FIG. 2 is a front plan view of the paging station information entry interface.

FIG. 3 is a schematic black diagram illustrating the remote paging method of the current invention.

FIG. 4 is a front plan view of the remote paging station apparatus.

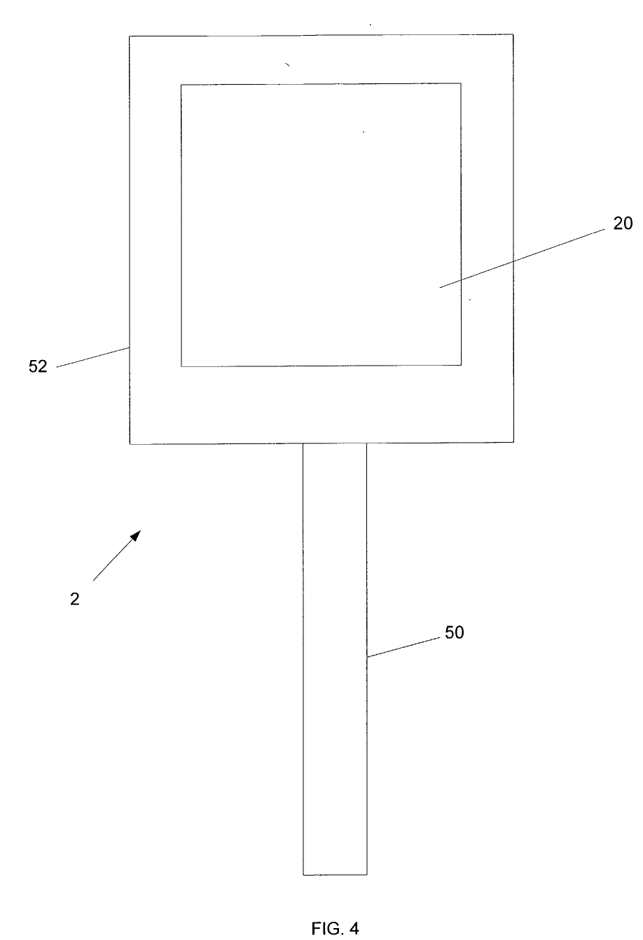

### DETAILED DESCRIPTION OF THE PREFERRED EMBODIMENT

The present description is of the best presently contemplated mode of carrying out the invention. This description is made for the purpose of illustrating the general principles of the invention and should not be taken in a limiting sense. The scope of the invention is best determined by reference to the appended claims.

All publications referenced herein are fully incorporated by reference as if fully set forth herein.

The present invention can find utility in a variety of implementations without departing from the scope and spirit of the invention, as will be apparent from an understanding of the principles that underlie the invention. It is understood that the remote paging and order fulfillment concepts of the present invention may be applied to business establishments of any kind including restaurants, grocery stores, video rental stores, pet supply stores, etc. It is also understood that while the present invention is best explained in reference to the food service industry, it will nonetheless have broad application in all areas of remote notification and order fulfillment systems.

One goal of this present invention is to provide a low cost, east to implement remote paging apparatus for use in order fulfillment systems. The remote paging apparatus of the current invention provides a low cost, wireless remote paging station for use in order fulfillment systems which is easily serviceable and enables simple entry of customer identification information into the remote paging station, translation of such information to a unique pager number, and transmitting of the information to a remote pager. In so doing, more customer orders may be processed and delivered during a given time frame, with increased levels of organization, efficiency, and customer service. The end result is more satisfied customers and increased revenues for the business.

Remote Paging System

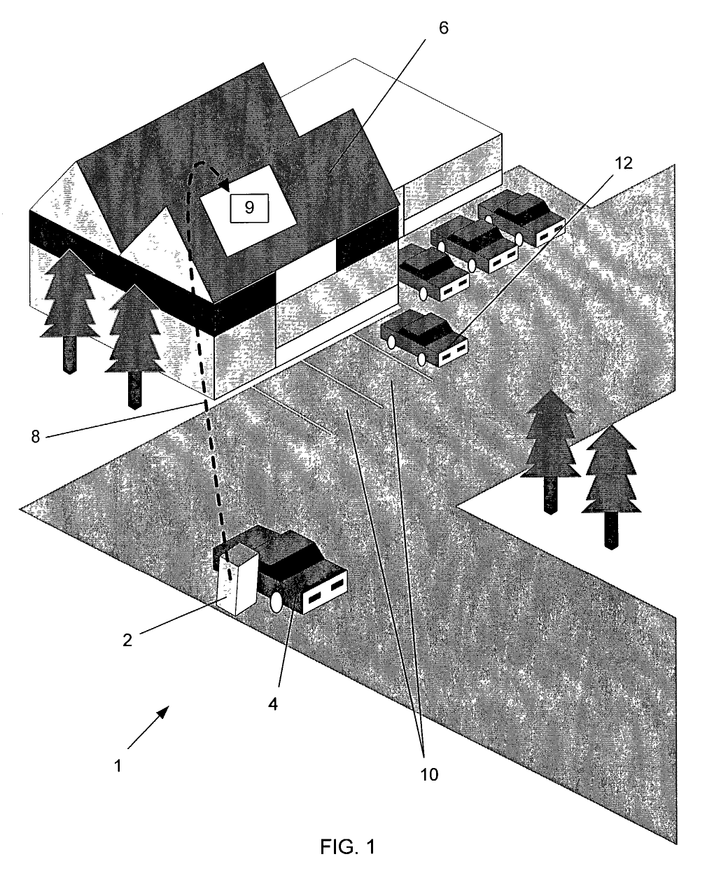

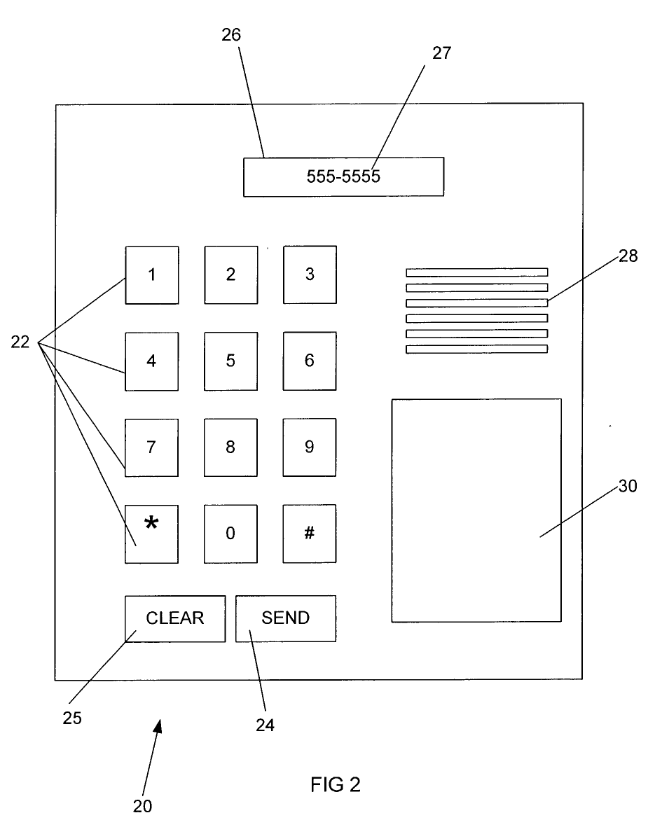

FIG. 1 shows the general configuration of the remote paging based order fulfillment system 1 according to one embodiment of the present invention- In the current system, a customer (not shown) in vehicle 4 who has previously placed an order with business 6 (a food establishment in one embodiment) arrives at remote paging station 2 in the vicinity of business 6 to initiate order processing and delivery. Remote paging station 2 is generally situated outside the building or physical structure occupied by business 6 such that remote paging station 2 is easily accessible to vehicles as shown in FIG. 1. Business 6 may also be located near or inside a larger physical structure (not shown) such as a mall or shopping center and would be identifiable to customers by business or trade name identifiers on the outside of business 6. It should be understood that remote paging station 2 may be situated differently depending on the needs and customer requirements of a business without departing from the spirit and scope of the current invention. For instance remote paging station 2 may be situated on an outside wall of business 6 such that it is easily accessible both to vehicles and pedestrians. Alternatively, in the situation where business 6 is inside a larger physical structure (such as a mall) the remote paging station 2 may be located on or near the business space occupied by business 6 in the mall. Once at remote paging station 2, the customer is prompted to, or simply enters previously specified identifying information using keypad 22 on the remote paging station interface panel 20 (shown in FIG. 2). In the preferred embodiment of the present invention, the customer's phone number 27 is delivered to an employee or attendant (not shown) of the business 6 during the placement of the initial order. The initial order may be placed via phone, but it is contemplated that other ordering means may be used (i.e. internet ordering methods) without departing from the spirit or scope of the present invention. The business employee assigns the customers phone number 27 to the order which was placed by the customer. This may be accomplished by physically attaching a slip of paper to packaging materials surrounding the customers order as is it prepared and processed, or may be entered into a pre-existing order processing system at the food establishment, including electronic order processing systems. In this case, the customer then inputs the same phone number 27 using keypad 22 upon arrival at the remote paging station 2. A transmitting means in remote paging station 2 transmits (illustrated by 8 in FIG. 1) the customer phone number 27 to a notification device 9 inside business 6. Notification device 9 is a pager worn by an employee in one embodiment of the present invention. Multiple employees may have pagers on which the customer phone number 27 is received, or one employee may be designated to receive and process to-go orders. It will be understood and appreciated that many different methods for distributing pagers and designating employees to process to-go orders are possible given the current invention, and such determinations will best be made by a particular business examining its own needs. It is additionally contemplated that notification device 9 may be integrated into an electronic order processing systems used by a business such that receipt of the customer identification information occurs in the electronic order processing system, which may then match such information with an earlier entered or assigned customer order number (corresponding to a customer order) which is then displayed to an employee of the business for processing and delivery.

In an additional embodiment of the remote paging system of the current invention, designated parking areas 10 are set aside by business 6 for use by to-go customers. After to-go customers have completed the above described order tasks, they may be directed to the designated parking areas 10 by signage (not shown) posted on or near the remote paging station 2. Such signage may be used to indicate the location and manner in which customers are to relocate prior to delivery of their order. FIG. 1 illustrates a customer in vehicle 12 having completed the arrival notification at remote page station 2 and having relocated to one of the designated parking areas 10 according to the current invention.

Remote Paging Apparatus

According to the current invention, there is provided a remote paging apparatus equipped with general-purpose data entry, display, and transmitting functions, and is used for entering customer identifying information and sending to a notification device. Remote paging station 2 illustrates a remote paging apparatus, and generally includes a base stand 50, durable weatherproof housing 52, regulated power supply with surge protection (not shown), built in circulating fan (not shown), a transmitter means (not shown), data translation means (not shown), and a user interface panel 20. The base stand and durable weatherproof housing may be fashioned from any number of metals, plastics, or other materials which are cost effective, easy to manipulate, and provide adequate protection for electronic components which will be placed in constant outdoor conditions. In general the height of the base stand should correspond to an average height of vehicles which will make use of the remote paging station (typically 30-45 inches). The base stand is affixed to the ground (which may consist of dirt, asphalt, concrete, etc) via any known method of attaching objects to the ground, such that the remote paging apparatus may not easily be removed from its set location. The regulated power supply is configured to provide a continuous 110V power supply to the remote paging station components, and may be fed by a power source which is run from the business either under the ground or above ground using known methods of electrical connection. The circulating fan is connected via wires or other electrical connection means to the power supply, and serves a purpose of cooling components inside the remote paging station. The transmitter means used in this invention is described in detail below. The data translation means of the current invention allows for customer entry of readily known information (i.e. their personal phone number) without requiring the knowledge of pager or other notification device numbers used by the business. In general the data translation means involves presetting the transmitter means to forward all customer identifying information to a single paging device number. Such presetting may be performed by those skilled in the art of paging technologies. In an additional aspect of the remote paging apparatus, the components and parts thereof are modular, thus allowing easy access and repair or replacement of the various components without removing or detaching the remote paging apparatus from the ground or other location to which it is affixed. For instance one or more sides of the weatherproof housing may be attached by screws which may be removed to easily gain access to components therein. Each component described above may be replaced individually, such that failure or malfunction of one component in the remote paging station will not require the replacement of others. In another embodiment, all or most of the inside components (including the power supply, transmitting means, circulating fan data translation means, and the user interface panel) may be mounted on a single side or plate of the paging station housing such that quick and easy removal and replacement of all components is facilitated without removal of the entire remote paging station. It should be noted that many different modular configurations of the paging station apparatus are possible (such that components or groups of components are removable and replaceable without requiring removal of the entire paging station) without departing from the spirit and scope of the current invention.

The notification device 9 according one embodiment of the present invention is a paging device generally including a housing, a power supply, a display means, and a receiver means, for receiving data sent by the transmitter means of the remote paging station. According to one aspect of this invention, one or more paging devices may be used in the current method, each preset to a single pager number of the transmitter means. In this way one or more paging devices may be set to alert employees in the business when a customer sends identifying information from the remote paging station. The paging device is typically very small in comparison to the remote paging station and is easily worn or carried by business employees. The paging device also generally includes an alerting means such as a vibration mechanism, sound mechanism, or light emitting mechanism. Paging devices as contemplated by this invention are well known in the art. Reference is made to the previously incorporated patent (U.S. Pat. No. 4,518,961) describing paging devices.

In another embodiment of the current invention, the notification device 9 may be incorporated into a large electronic order processing system, wherein receipt of the customer identification information occurs in the electronic order processing system rather than individual paging devices worn by employees. The electronic order processing system then matches received customer identification information to existing order numbers and then displays order information to employees for processing and delivery.

The transmitter and receiver means used by the remote paging station 2 and notification device 9 are POCSAG protocol devices and may use the UHF band to transmit information according one embodiment of the present invention. POCSAG based transmitting and paging devices are well known in the art. The remote paging station 2 may contain any transmitter which is able to send customer identifying information to the notification device 9. For instance wireless transmitters and pagers (such as the GEO N6V PULSER made by Scope Communications) may be used in the current invention. In general, the remote paging system and methods of the current invention are not limited to UHF band technologies, and may include VHF, WiFi, Bluetooth, RF, cellular, infared, or other wireless technologies to implement the inventive aspects of the current invention. Additionally, both transmitters and receivers capable of sending and displaying alphanumeric characters may be used enabling other customer identifying information to be sent according to the current invention. For instance, using such alphanumeric devices, a customer's last name could be the identifying information used according to the current invention rather than a telephone number.

FIG. 2 shows the user interface panel 20 of remote paging station 2. User interface panel 20 enables the entry of customer identification information 27 into remote paging station 2, and the notification device 9 enables the notification and delivery of customer identification information to one or more employees of business 6. Keypad 22 is the interface for customer data entry, and may be backlit for nighttime visibility. Clear button 25 is placed near keypad 22 for customers to cancel previously entered information and begin data entry again. Clear button 25 would be used for instance if a customer entered identification information incorrectly before hitting send button 24, in which case the customer could reenter the correct information before sending. Send button 24 is placed near keypad 22 for customers to initiate the transmitting of information from remote paging station 2 to the notification device 9 used by business employees. Display 26 is a Light Emitting Diode (LED) or similar display mechanism for displaying customer information as it is entered, and for displaying preset messages to the customer before and/or after data entry (for instance the LED may be set to direct customers to a designated parking area following the entry of their information). Shown in the display 26 is customer identifying information 27, which according to one embodiment is the customers phone number. Fan vent 28 is shown to enable cooling functions of remote paging station 2. Fan vent 28 may be placed on any location of the remote paging station 2. Business decal 30 is shown to indicate the trade name of the business and/or any other relevant information which customers may need to know during the remote paging process.

In an alternate embodiment, user interface panel 20 does not include display 26 for displaying customer information as it is entered, but rather includes a light or similar visible means for verification to the customer that entered information was sent successfully. The light can be mounted on or in user interface panel 20 in any manner such that it is visible to the customer entering information, and may be connected to the transmitter inside housing such that it is activated only after paging messages are sent successfully. It should be appreciated by those skilled in the art that other verification means (such as sound or other audible means) could be used, and further that the current invention need not contain any verification means in order to provide the benefits described herein. For instance, user interface panel 20 need not contain a display 26 or any other verification mechanism to allow for input of customer identifying information.

Method of Using the Remote Paging System

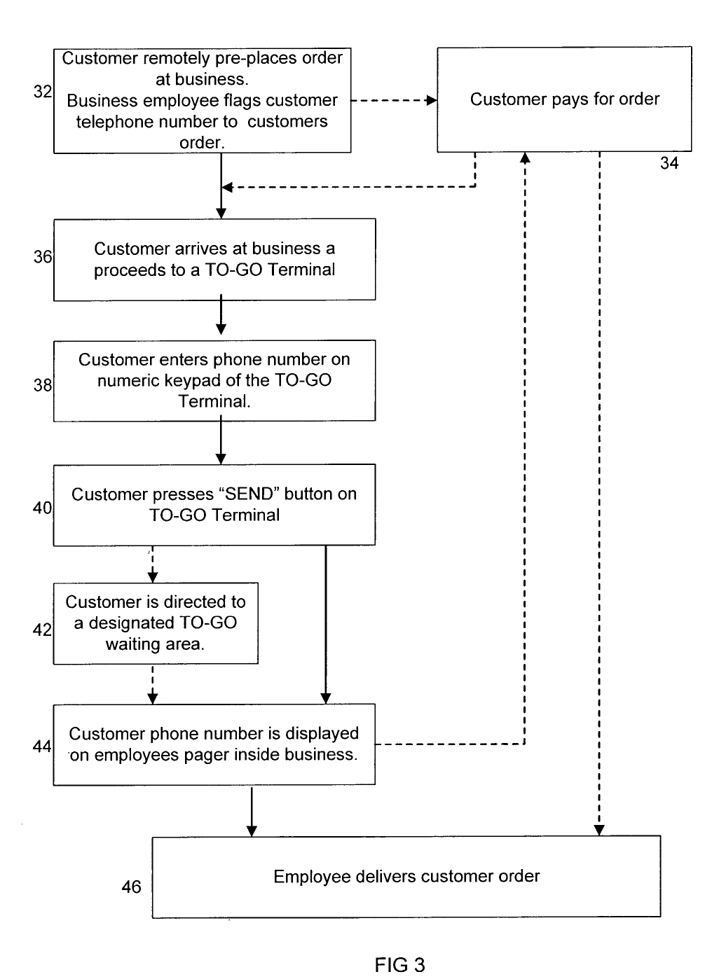

A method of using the order fulfillment system and notification apparatus of the present invention is disclosed. FIG. 3 shows the process steps of the method according to the present invention. Initially, an order placement and information designation step 32, wherein a customer pre-places an order at a business (a restaurant of food service establishment according to the preferred embodiment) and delivers personal identifying information (such as a phone number) to an employee of the business is performed. In step 32 the customer remotely pre-places an order at the business. As described above, such order can by placed via telephone, internet, or other means. In this same step, an employee at the business notes the customers telephone number (or other desired identifying information) and flags it for the customers pending order. Optionally after step 32, is a payment step 34. The order payment of step 34 may be performed using any number of known payment methods. In the preferred embodiment of the present invention the customer payment information is given to the employee while the order is being placed. In this way the order may be processed more quickly following customers arrival at the business for order pick up. In an alternate embodiment of the present invention, the payment step is performed during data entry step 38, and may replace the phone number input by the customer. For instance if the remote paging station 2 is equipped with credit/debt card, smart card, or similar card reading apparatus (not shown) for processing of payments, the customer may pay for the order using such card reading apparatus. Identifying information from the transaction is then sent to the employee's wireless pager (not shown) for notification and order designation purposes. After step 32 (or 34 if the customer has elected to pay while the order is being placed), is the arrival step 36 wherein the customer arrives at the business 6 and proceeds to a remote paging station 2 outside the business. Upon arriving at the business 6, the customer proceeds to the remote paging station 2 according to the current invention. Following step 36, the customer performs data entry step 38, wherein customer personal identifying information 27 (such as the previously specified phone number to a business employee) is entered into a keypad 22 on the remote paging station 2. As described above, payment step 34 may be performed with the data entry step according to an alternate embodiment of the present invention. Following step 38, the customer initiates send step 40, wherein the input customer identifying information 27 is transmitted (illustrated as 8 in FIG. 1) from the remote paging station to a notification device 9 within the business 6. In another embodiment 42, the customer arrives at the business 6 in a vehicle 4 so they may be later directed to designate parking areas 10 for order delivery. It should be appreciated that the particular method of customer arrival at the business for order pick up does not effect inventive aspects of the current invention. It is also contemplated that the present invention may be used in situations where customers themselves (without vehicles) are directed to designated waiting areas without departing from the sprit and scope of the present invention. Such designated areas (for parking or waiting) which have been previously marked for customers may be indicated as such by signage posted on or near the remote paging station 2 and may be used to indicate the location and manner in which customers are to relocate prior to delivery of their order. Following step 40 (or optional step 42) is notification step 44, wherein the notification device 9 alerts an employee (who may be wearing the notification device, according to one embodiment of the current invention) and displays the customer's personal identifying information, thus indicating to the employee both the customers status and order information, is performed. During this step the employee also matches the customers identifying information to the particular order that has been tagged with such information. Following step 44 is delivery step 46 wherein the employee delivers the customers order to the customer.

As described above the paging based order fulfillment method, system, and apparatus according to the present invention allow customers to pre-place orders with a high quality restaurants, pay for the orders using a variety of different methods, and receive their orders once at the restaurant without ever leaving their vehicle. The benefits to restaurant owners include the ability to keep employees busy while waiting to processes to-go orders, instant notification of arriving customers for order pick up, easily identifiable information displayed on employee pagers for matching customer orders to arriving customers, increased speed and reduced labor effort on employees in order processing (thus increasing productivity) and simple cost effective remote paging system maintenance.

The method, system, and apparatus of the present invention has been described above in terms of system level diagrams and functional modules in block diagram format. It is understood that unless otherwise stated to the contrary herein, one or more functions may be integrated in a single physical device, or one or more functions may be implemented in separate physical devices, without departing from the scope and spirit of the present invention. For instance, the functions of the notification device may be implemented in new or currently existing electronic order processing system used by the business establishment such that receipt of customer identification information (including credit card or similar payment information according to one embodiment) occurs in the electronic order processing system which then matches such information to existing order information and displays relevant order information to employees for order processing and delivery. Furthermore, the goals of the present invention may be accomplished using a number of known devices and communication means, such as VHF and UHF paging devices using the POCSAG protocol, cellular technologies, WiFi systems, etc. Additionally, the system components (such as the remote paging station) may be configured in many possible locations on or outside business in order to accomplish the goals of the present invention without departing from the spirit of scope of the present invention.

It is appreciated that detailed discussion of the actual implementation of each system and apparatus element is not necessary for an enabling understanding of the invention. The actual implementation is well within the routine skill of a system engineer, given the disclosure herein of the system attributes, functionality and inter-relationship of the various functional modules in the system. A person skilled in the art, applying ordinary skill can practice the present invention without undue experimentation. While the invention has been described with respect to the described embodiments in accordance therewith, it will be apparent to those skilled in the art that various modifications and improvements may be made without departing from the scope and spirit of the invention. Accordingly, it is to be understood that the invention is not to be limited by the specific illustrated embodiments, but only by the scope of the appended claims.

1. A notification system for customer order fulfillment at an establishment of an earlier placed order, comprising:
a customer interface in the vicinity of said establishment for accepting customer specific information from a customer;
a notification means in said establishment for providing said customer specific information to facilitate identification and fulfillment for said customer of an earlier placed order by an attendant; and
a communication means for transmitting said customer specific information to said notification means.

2. A notification system as in claim 1, wherein said customer specific information consists of a series of alphanumeric characters.

3. A notification system as in claim 2, wherein said series of alphanumeric characters corresponds to the telephone number of said customer.

4. A notification system as in claim 1, wherein said customer interface is located outside of said establishment.

5. A notification system as in claim 4, wherein said establishment exists within a physical structure having it's own business identity and said customer interface is located outside said physical structure.

6. A notification system as in claim 5, wherein said customer interface is accessible by a vehicle.

7. A notification system as in claim 1, wherein said customer interface further comprises:
a stand,
a housing supported on said stand, and
a user interface panel supported by said housing.

8. A notification system as in claim 7, wherein said user interface panel further comprises:
a data entry means, and
data transmitting initiation means.

9. A notification system as in claim 8, wherein said data entry means comprises a keypad.

10. A notification system as in claim 8, further comprising a verification means for notifying said customer when said customer specific information is transmitted to said notification means.

11. A notification system as in claim 10, wherein said verification means comprises a visible verification means.

12. A notification system as in claim 1, wherein said communication means consists of a wireless communication means.

13. A notification system as in claim 12, wherein said wireless communication means is compatible with at least one of the groups consisting of VHF signals, UHF signals, WiFi signals, Bluetooth signals, cellular signals, RF signals, and infared signals.

14. A notification system as in claim 12, wherein said wireless communication means is compatible with the POCSAG protocol.

15. A notification system as in claim 1, wherein said notification means is display.

16. A notification system as in claim 1, wherein said notification means is a portable receiving device.

17. A notification system as in claim 16, wherein said portable receiving device is a pager.

18. A notification system as in claim 1, wherein said establishment is a food service establishment.

19. A notification system as in claim 18, wherein said food service establishment is a restaurant.

20. A notification method for customer order fulfillment at an establishment of an earlier placed order, comprising the steps of:
providing a customer interface in the vicinity of said establishment for accepting customer specific information from a customer;
providing a notification device for receiving said customer specific information in said establishment;
inputting by a customer of customer specific information into said customer interface;
transmitting said customer specific information to said notification device;
notifying an attendant using said notification device for facilitating identification and fulfillment for said customer of an earlier placed.

21. A method for fulfilling customer orders in a business, comprising the steps of:
(a) remotely placing an order at a business by a customer, said order also containing customer identification information;
(b) applying of said customer identification information to said order by an employee at said business;
(c) proceeding by said customer to a customer interface in the vicinity of said business;
(d) entering by said customer of said customer identification information in said customer interface;
(e) sending by said customer of said customer identification information to a notification device for alerting an employee of said customers status;
(f) matching by the employee of said customer identification information to said order for identification of said order;
(g) delivering the order.

22. A notification method as in claim 21, wherein said placing step further comprising the step of paying for said order.

23. A notification method as in claim 22, further comprising the step of paying for said order after said matching step.

24. A notification method as in claim 21, further comprising the step of sending said customer to a designated waiting area before said delivering step.
